(19) United States
(12) Patent Application Publication
(10) Pub. No.: US 2016/0132884 A1
(43) Pub. Date: May 12, 2016

(54) REAL-TIME PAYMENTS THROUGH FINANCIAL INSTITUTION

(71) Applicant: PAYPAL, INC., San Jose, CA (US)

(72) Inventors: Arkady Fridman, Twain Harte, CA (US); Peter Amalraj, San Jose, CA (US); Mamta Narain, Fremont, CA (US); Katherine Wilson, Campbell, CA (US); Daniel Schatt, San Mateo, CA (US)

(21) Appl. No.: 14/996,185

(22) Filed: Jan. 14, 2016

Related U.S. Application Data
(63) Continuation of application No. 13/308,248, filed on Nov. 30, 2011.
(60) Provisional application No. 61/418,313, filed on Nov. 30, 2010.

(51) Int. Cl. G06Q 20/40; G06Q 20/10

(52) U.S. Cl. CPC G06Q 20/4014; G06Q 20/10

(57) ABSTRACT

A payment provider uses bank rails to enable a bank customer to send real-time payments through the bank site by simply entering a recipient identifier, such as an email address or mobile number. The bank has an account with the payment provider. Thus, when the customer sends a payment through the bank, the payment provider transmits the payment to the recipient through the bank's payment provider account. The bank debits the amount from the user's bank account or from a third party, in which case the bank makes a payment to the third party. The sender does not have to have an account with the payment provider, just an account with the bank.

### CROSS REFERENCE TO RELATED APPLICATIONS

This application is a continuation of U.S. patent application Ser. No. 13/308,248, filed Nov. 30, 2011, which claims priority to U.S. Provisional Patent Application No. 61/418,313, filed Nov. 30, 2010, the contents of which are incorporated herein by reference in their entirety.

### BACKGROUND

1. Field of the Invention

The present invention generally relates to electronic financial transactions and in particular to financial transactions involving two financial entities.

2. Related Art

Typically, consumers make payments to others through their bank, such as by writing checks drawn from the consumer's bank account. However, paper checks have many disadvantages, including risk of fraud, costly to use (print and mail), prone to errors in writing the check, inconvenient (need access to check and mailing address of recipient), and time-consuming (write and mail the check). Payment providers, such as PayPal, Inc. of San Jose, Calif., enable users to make payments electronically through a user device, such as a smart phone or PC. Banks also allow payments through debit cards. However, such payments can only be paid at the POS with a card reader.

More recently, banks have allowed consumers to pay bills electronically through a bill pay service. This typically requires the consumer to enroll for each payee, which can be time-consuming. Once enrolled, the consumer can pay bills to designated payees. However, there may be a delay in sending payment and for the payment to be received, such as if the payee's account is in a different network than the consumer's bank.

Third party payment providers enable users to make payments directly to others through accounts held by the payment provider. However to use such services, both the payer and the payee must have accounts with the payment provider. Thus, a payment cannot be made from a payer having an account to a payer without an account or from a payer without an account to a payee with an account.

Therefore, there is a need for a person to person payment service that overcomes the disadvantages of conventional methods discussed above.

### SUMMARY

In one embodiment of the present invention, a service or payment provider, such as PayPal, uses bank rails to enable a bank customer to send real-time payments through the bank site by simply entering a recipient identifier, such as an email address, mobile number, or other easily shareable identifier. The bank has an account with the payment provider. Thus, when the customer sends a payment through the bank, the payment provider transmits the payment to the recipient through the bank's payment provider account. The bank debits the amount from the user's bank account. The sender does not have to have an account with the payment provider, just an account with the bank. A user having an account with the payment provider can also make a payment to a user with a bank account, but no account with the payment provider. In this situation, the payee may get a notice that funds are waiting and to open an account to retrieve the funds. Thus, the payer and payee are not required to both have an account with the payment provider in order to make a person to person (P2P) payment.

In other embodiments, the payment provider may utilize a user's bank information to make purchases, add the bank as a funding source, and confirm or authenticate the user. For example, the payment provider may authenticate or confirm a user through the bank instead of random deposit or other means, utilizing bidirectional rails with the bank. Also, using bank rails, if a user wishes to make a payment through an account with the payment provider, but the account does not have enough funds to cover the payment amount, the payment provider can see what the user has in a bank account. If adequate funds are available, a hold may be put on those funds. The payment provider can then approve the payment, with funds being pulled from the user's bank account through the bank's payment provider account and into the user's payment provider account.

Other uses include the ability for insurance companies to make real-time payments to payees, such as body shops, through the payment provider by giving to the payment provider the email address or phone number of the payee. Another use is the ability to buy and sell mutual funds, stocks, bonds, etc. through the payment provider. The distribution of dividends may be through the payment provider. This results in easier and more instantaneous distributions. This also allows instantaneous funds into a brokerage account, resulting in the ability for the user to buy stocks/funds immediately. Yet another use case is funding the bank account through the payment provider and liquidating bank accounts through the payment provider for real-time funding and liquidation. Other use cases are also possible when real-time money movement through banks is desired.

The financial institution need not be banks. For applications where the user wants to obtain or deposit money, any store or establishment may be used. If the store has an account with the payment provider, the store may dispense money to the user and have the store's payment provider account credited, or the store may receive money from the user and have the user's payment provider account credited and the store's payment provider account debited in the appropriate amount.

In another embodiment, a user can manage the user's bank accounts through the user's payment provider account. This utilizes the bank's rails to link the user's bank account with the user's payment provider account, enabling the user to perform various banking transactions through the user's payment provider application or site instead of having to go to the bank site.

The above provides many benefits. Financial institutions can offer real-time payment capabilities to their customers through various banking channels (e.g., web, mobile, ATM). Consumers can log into their banking application or site through these various banking channels and send payments to anyone, anywhere, in real time using only an email address or a mobile phone number. Bank customers do not need a payment provider (such as PayPal) account to send money. Recipients will have their money instantly deposited into their payment provider accounts if they are a registered account holder. If the recipient does not have an account with the payment provider, they can open an account quickly and easily to immediately access their funds.

Thus, bank customers can now benefit from the immediacy of payment. By having an electronic record of their transactions, consumers can consolidate all their payment activity at the bank and interact with more payees, which can be a significant retention and engagement tool for banks. A single integration can allow banks to offer their customers these benefits across many different bank channels in a seamless fashion.

The ability to make real-time payments through an email address or a mobile number can significantly increase customer engagement with banks. Banks can enable larger variety of user transactions and fulfill many customer payment needs which make bank applications more relevant and top-of-mind for customers.

Consumers benefit by having a more convenient solution to traditional cash and check payments. Bank customers can now track payees in a consolidated manner. For example, babysitting, rent, international payments, etc., can be tracked in addition to credit card and utility bills all on the bank's website.

Financial institutions benefit from incremental online and mobile payments activity, more monetizable cross selling opportunities, and increased deposits. Financial institutions can also leverage email capabilities for viral marketing opportunities every time a payment is sent, enabling banks to sell their services to payment recipients when they open the “You've got funds” email.

The viral nature of email payments offers the ability for banks to reach profitable customer segments across multiple channels. Banks can also benefit by gathering more behavioral and transactional data on their customers and can develop insightful personal management applications that drive even more engagement for their customers.

Banks may have full control of the application layer and user experience. The payment provider capabilities can be easily integrated into a bank's existing website. The integration can be a simple API based integration, which can be leveraged across multiple bank channels (web, mobile, ATM).

These and other features and advantages of the present disclosure will be more readily apparent from the detailed description of the embodiments set forth below.

### BRIEF DESCRIPTION OF THE FIGURES

FIG. 1 is a flowchart showing one embodiment of a process a user performs in making a financial transaction through a banking or other financial institution site;

FIG. 2 is a flowchart showing one embodiment of a process a bank or financial institution performs in making a financial transaction initiated by a user through the bank or financial institution site;

FIG. 3 is a flowchart showing one embodiment of a process 300 a service or payment provider performs in making a financial transaction initiated by a user through a bank or financial institution site;

FIGS. 4A-4J are exemplary screen shots of various stages of a payment process described herein;

FIGS. 5A-5C are exemplary screen shots a payee sees after a payment is sent from a user's financial institution site or app;

FIGS. 6A-6C are exemplary screen shots a user or sender sees for making a payment through the user's financial institution;

FIG. 7 shows an embodiment of a networked system used in the payment processes described herein;

FIG. 8 shows an embodiment of a device that can be used as one or more devices described herein; and

FIG. 9 shows an embodiment of a computer system suitable for implementing one or more devices described herein.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

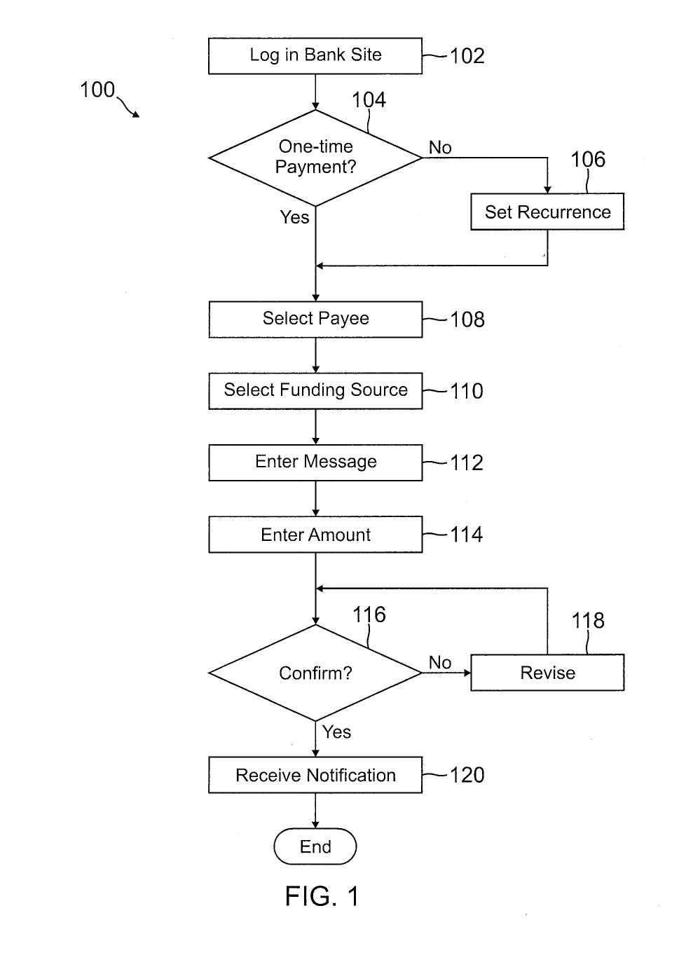

FIG. 1 is a flowchart showing one embodiment of a process 100 a user performs in making a financial transaction through a banking or other financial institution site. At step 102, the user logs into the user's banking site through the user's mobile device, such as a smart phone. The user may also log into the banking site through other user devices, such as a tablet, PC, laptop, etc. The user access the site, such as through a browser or a mobile App/browser, and enters the requested information, which may include a user identifier (user name or email address) and password or PIN, for login.

Once logged into the bank site, the user may see a home screen with a link, tab, button, or other the like that allows the user to make a payment through the user's bank account. Selecting the feature takes the user to a screen for entering/selecting information for the payment. Note that the following steps need not be performed in the order illustrated, but can be performed in different order, and all steps are not required. Also, two or more steps may be combined, as opposed to being performed separately.

At step 106, the user selects whether the payment is to be a one-time payment or will be a recurring payment. The user may select a button or link for a one-time payment or a recurring payment on the user device display from the banking site. If the payment is to be recurring, such as with a bill payment. The recurring payment may also be for periodic payments to repay a loan, provide support for a child, family member, or friend, or make charitable contributions.

For a recurring payment, the user can set the recurrence at step 106. For example, the user may set a recurrence for a payment every month on a particular day, every two months, or some other time period. The user may also set an end date for the payment recurrence. This can be done through a calendar feature or by the user simply entering the recurrence period and end date, if applicable, through a data input of the user device, such as a keypad, keyboard, or microphone. The user may also set a payment date if the payment is not to be immediate.

At step 108, the user selects a payee or recipient of the payment. This can be done in any number of ways. For example, the user may enter an identifier of the payee, such as an email address or mobile phone number. The user may type in the identifier or speak it into the user device. Alternatively, the user may select the payee from a list, such as a user contact list on the user device or other list available to the user. Selecting the desired payee from a list may fill the payee field with the user identifier, such as an email address or mobile phone number. Note that other identifiers may also be possible to identify the payee to the bank and/or the payment provider.

The user may also select, at step 110, a funding source for the payment. This may be skipped if the user has set a default funding source or if there is only one funding source available. Examples of funding sources include different accounts of the user with the bank, such as a checking account, a savings account, a money market account, a credit card, etc. Each of these types of accounts may have multiple options available. For example, a user may have an individual checking account, a joint checking account, and a business checking account. The user may be presented with a list of available funding sources by the bank, such that the user can simply click on, tap, or otherwise select a link, button, or icon representing the specific funding source. The user may select a default funding source that can be changed by the user for each payment request. Furthermore, the user may only select a portion of all funding sources associated with the account as an available funding source for this type of payment.

A message may optionally be included with the payment to the payee. If the user wishes to include such a message, the user may enter the message, at step 112. Message entry may be accomplished in different ways, such as typing the message from a device keypad or keyboard, speaking the message into the user device, which can be translated into text or sent as an audio file, or selecting a pre-composed message from a list and editing as needed.

Next, the user may enter an amount of the payment at step 114. Again, this can be done in any suitable manner. Examples include entering the amount into a specified field on the display device, speaking the amount into the device, and selecting from a list of amounts. In one embodiment, a currency may be selected as well, with a default currency being the location of the bank or user or set by the user.

After the requested or desired information is entered or selected, the user may be asked to confirm the information at step 116. This includes making sure the payee is correctly identified, the proper amount is shown, the correct funding source is identified, and the message, if any, is correct. If not, the user may revise, at step 118, such as by selecting the field or portion in error and entering or selecting the correct information.

Once the user confirms the details of the payment, such as by selecting a “confirm” button/link or the like, the payment request is processed. After processing, the user receives a notification, which can be on the same user device, about the payment request. The notification may be on the same screen or different screen where the payment request was made, such as on the banking site. In other words, the user can initiate the payment and receive notification of the payment request all through the user's bank site. The notification may be one of confirmation that the payment was made or a denial that the payment request could not be completed. The denial may include reasons, such as insufficient funds, not a valid payee (e.g., could not be identified), etc. The user may be given the option of correcting the reason(s) and resubmitting the payment request.

Thus, the user can make a direct payment to a payee through the user's banking or financial institution quickly and easily by simply entering a payee's email, mobile phone number, or other identifier.

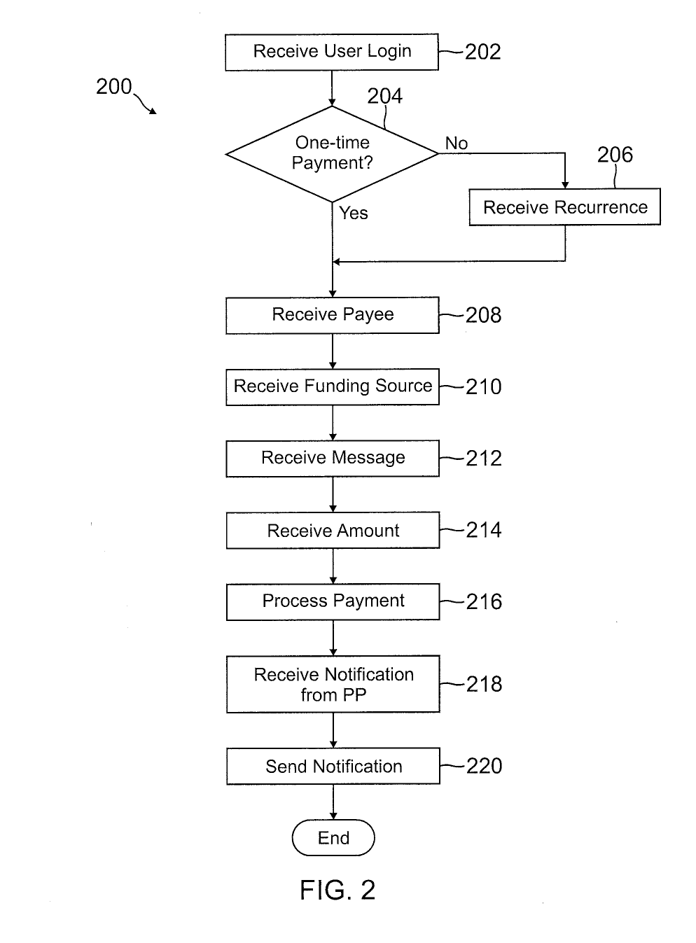

FIG. 2 is a flowchart showing one embodiment of a process 200 a bank or financial institution performs in making a financial transaction initiated by a user through the bank or financial institution site. At step 202, the bank, through a browser, a mobile browser, or the bank's mobile App, receives user login information through a user device, such as a PC or smart phone. The login information includes a user identifier, such as a user name or email address and a password or PIN. The bank uses this information to access the user's account and provide the user with access to the account.

Once the bank receives an indication from the user that the user wishes to make a payment, the bank provides the user with a page or pages on the user device that enable the user to enter or select information necessary to process the payment request. In one embodiment, the bank may also communicate, by voice, a request for the user to respond back with the requested information. This can be through interactive voice response (IVR) or other voice technology.

As with the process of FIG. 1, the following information received by the bank may be received in a different order, partially or fully combined, and/or not all required for by the bank. At step 204, the bank makes a determination whether the user wishes to make the payment a one-time payment or a recurring payment, such as through a user communication via the user device from a bank site page to a bank server. If a recurrence is indicated, the recurrence details are received at step 206. Details may include the period of recurrence and an end date, if desired.

At step 208, payee information is received. In one embodiment, the information is the email address of the payee. In another embodiment, the information is a mobile phone number of the payee. These can be received through manual entry by the user through the bank site or by the user selecting a desired payee through a contact list.

Next, the desired funding source is received at step 210. This may be a default funding source selected by the user or one of a plurality of funding sources associated with the user's bank account. In one embodiment, the user may select more than one funding source for the payment. For example, the user may select $10 to be from the user's checking account and $90 from the user's savings account for a $100 payment.

If the user wants to include a message to the payee with the payment, the message is received by the bank at step 212. The message may be a description of what the payment is for or anything else the user wishes to convey with the payment. The message can be sent or received by text or voice.

At step 214, the bank receives a payment amount from the user. The amount is received through the bank site from the user device and can be from a user entering the amount or selecting the amount from a list of amounts. Optionally, the currency can also be specified.

Once the payment information is received, the bank processes the payment at step 216. This may include determining if there are any restrictions associated with the account. For example, the payment service may require the user to specifically sign up and/or authorize the service prior to use. The service may also allow the user to place certain restrictions for security, such as limits to a payment amount, limits to the number of payments allowed within a certain time period, restrictions on who payees can be (i.e., designation of authorized and/or unauthorized payees), etc. The bank may also utilize risk analytics, such as where the user made the request, which can be based on IP address, device IDs, or location services available from the user device.

If the payment cannot be approved, the user may be given an opportunity to correct. For example, the payment amount may exceed what is allowed for a certain funding source. The user can change the funding source or allocate a portion of the payment to another funding source. If the bank cannot ultimately approve the payment request, the user is notified accordingly at step 218. Notification may be through the user's device or another through another contact associated the account, such as by calling to a user's home phone, mailing to the user's home/billing address, or faxing to a user's business.

If the payment can be approved, processing at step 216 may include debiting the one or more designated funding sources of the user bank account(s) by the appropriate amount(s). The bank may send funds to the payment provider or to a third party, such as an aggregator, if the third party is making payments to the payment provider. Note that it is possible for a user account to be debited in an amount higher than what is in the balance, such as if the user has some type of overdraft protection. The ability to do this will vary depending on the bank.

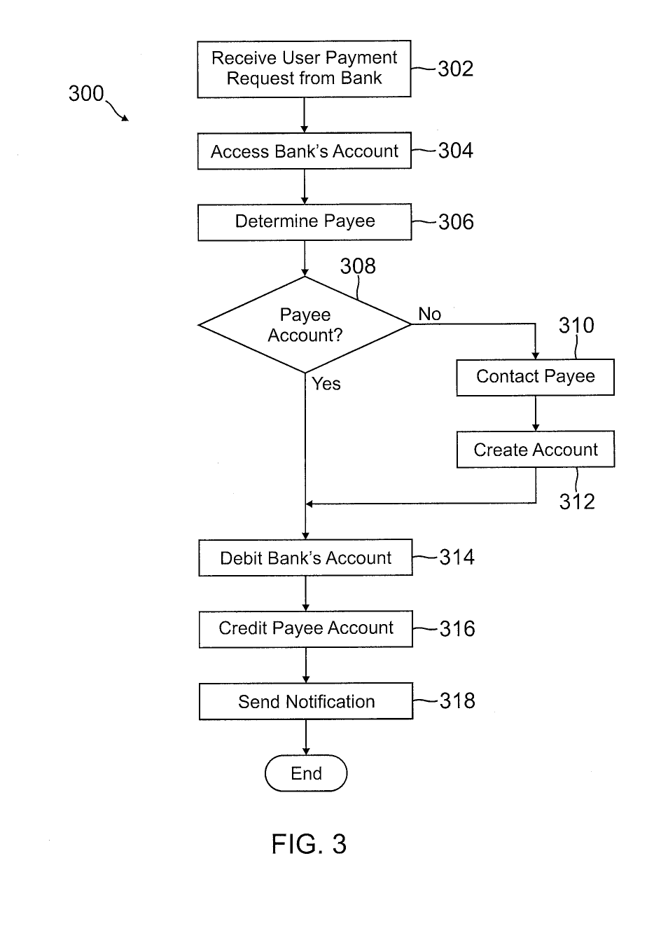

Processing may also include sending a notification to the payment provider that sufficient funds are in the user's account(s) to make the payment. For example, a bank server may communicate information to a payment provider server. The information may include a confirmation that the bank has approved the sender, the payment amount, and the identification information of the payee. This allows the payment provider to then process the payment on the payment provider side, which will be discussed with respect to FIG. 3.

The payment provider, as part of its processing, determines whether the payment can be completed. Reasons a payment may not be completed is if the payee cannot be properly identified by the received payee identification information. For example, the identifier may be a mobile phone number, but the phone number is not in use, or the identifier may be an email address, but the email address is not valid (such that emails sent to the email bounce back as undeliverable).

If the payment provider cannot complete the payment, the bank receives a notification, at step 218, indicating that the payment could not be completed. The notification may include a reason, such as not being able to identify the payee. If the payment potentially can be completed, such as correct identification of a payee, the bank may send a notification, at step 220, to the user indicating the problem and requesting the user revise any needed information to remedy. For example, the user may be asked to enter another identifier for the payee. Newly received information may then be communicated by the bank to the payment provider for processing again at step 216.

If the payment ultimately cannot be completed, the bank may receive such a notification at step 218 from the payment provider, along with any reasons if available, and a notification is sent to the user, by the bank, at step 220, informing the user that the payment request was denied. A reason may be provided with the notification. The funds debited from the user's account may then be credited back into the user's bank account(s). Note that funds need not be debited until the bank receives confirmation from the payment provider that the payment transaction can be or is completed.

If the payment provider can complete the payment, a notification is sent by the payment provider and received, at step 218, by the bank, informing the bank that the payment has been approved. The bank, upon receiving confirmation, may send a notification to the user, such as through the bank site and to the user device, that the payment has been sent. The notification may include the amount sent, payee information, and other information, such as time/date sent, whether the payment was received or picked up by the payee, and if so, the time/date received, and a transaction number for the payment.

FIG. 3 is a flowchart showing one embodiment of a process 300 a service or payment provider performs in making a financial transaction initiated by a user through a bank or financial institution site. Note that the steps described here can be performed in a different order, combined in different combinations, and/or omitted in part. At step 302, the payment provider receives, such as at a server, a user payment request from a bank. The request is made by the user through a user device from the user's bank account, such as an API call from the bank site to the payment provider. The bank then sends the request to the payment provider, such as from a bank server to a payment provider server. The request may be sent after the bank has determined that the user has sufficient funds to cover the payment and the bank is able to make the payment. The request may include bank information, payee identification information, such as an email address or mobile phone number, user or payer information, such as a name, user name, email address, and/or phone number, amount of payment, and payment date, if applicable.

At step 304, the payment provider accesses the bank's account with the payment provider based on the information received at step 302. The information may include the bank's name, account number, or other identifier that allows the payment provider to determine whether the bank has an account with the payment provider. If the payment provider cannot locate the bank's account or the bank's account is inactive, the payment provider may send a notification to the bank to create an account or to active the dormant account. The bank's account may be opened or activated in similar fashion to any other user account with the payment provider, such as providing requested information, typically including a funding source.

Next, at step 306, the payment provider determines the payee from the information received. For example, the payment provider may receive an email address or a mobile phone number from the bank or the user through the bank's site. Other user identifiers may also be possible that enable the payment provider to determine an identity of the payee.

Once identified, the payment provider determines, at step 308, whether the payee has an account with the payment provider. This can be done by the payment provider searching through its database or one accessible or managed by the payment provider to determine whether the payee or the payee identifier is associated with an account with the payment provider.

If no account could be located or if an invalid or inactive account was located, the payment provider may contact the payee at step 310. The payment provider may contact the payee through received information or through information from an invalid or inactive account. For example, the payee may be contacted through a mobile number (such as by voice or text) or an email address with an email. The message may inform the payee that a payment has been made to the payee and that the payee will need to create or activate an account to retrieve the funds. The message may also include a link that the payee can access to be taken to the payment provider for opening or activating an account.

At step 312, the payee can create (or activate) an account, such as by entering or providing information requested by the payment provider. Such information can include an address, a phone number, a password or PIN, a user name, an email address, one or more security question answers, one or more funding sources, etc.

Once the payee account is created (at step 312) or identified (at step 308), the payment provider may proceed with processing the payment. At step 314, the payment provider may debit the bank's account with the payment provider, identified at step 304, by the appropriate amount. This may be in response to a settlement report sent by the payment provider to the bank, where the bank then sends a payment (via wire or ACH for example) to the payment provider. The amount may be the exact amount of the payment, but it also may be more or less depending on any fees charged or credit given to the bank. In other embodiments, the payment provider may obtain payment from a third party, such as an aggregator. In this case, the bank may debit an account of the third party with the payment provider or receive payment from the third party through wire or ACH in response to a settlement report sent to the third party. The third party may receive funds from the bank to cover the payment. The payment provider may settle accounts at any set period, such as at the end of the day, or after each transaction.

The payee's account with the payment provider may then be credited with the payment amount at step 316. Thus, the payee is paid through the bank's account with the payment provider, and the bank receives funds from the user or sender's account with the bank. This enables the user to easily make a payment through a bank account without the user having to have an account with the payment provider. The user does not need to go through any cumbersome sign-up process and can designate any payee simply with an email address or phone number.

Once the payment is made and completed, the payment provider may send a notification, at step 318. The notification may be sent to the bank, the user, and/or the payee, where the notification may include an indication that the payment has been made. For example, the payment provider may send the user a notification indirectly through the bank site. Notification can be in any suitable way, such as text, voice, email, etc.

In other embodiments, the payment provider may utilize a user's bank information for different uses. In one embodiment, the payment provider can authenticate the user through bank information, such as obtaining the user's account information, name, address, phone number, user name, etc.

In another embodiment, the payment provider can utilize knowledge of available funds from the user's bank account(s) to approve or deny a purchase through the payment provider. For example, if the user is making a payment request through the payment provider, such as through an app or the user's account on a web page, and there are insufficient funds in the user's account with the payment provider, the payment request may still be approved. In that situation, the payment provider may access the user's one or more of the user's bank or other financial institution accounts to determine available funds.

If the user has sufficient funds available (e.g., either will current balance(s) and/or overdraft protection), the payment provider can place a hold on the required funds and approve the payment request. The payment provider may then make the payment on behalf of the user, utilizing some or all of the funds from the user's payment provider account and the remaining amount from the payment provider itself, from a third party account with the payment provider, or with a bank account with the payment provider. The held funds from the user account(s) of the bank may then be released to the appropriate party, e.g., the bank, the payment provider, or the third party. As a result, a user may be able to complete a purchase or payment request through the payment provider even if insufficient funds exist with the payment provider.

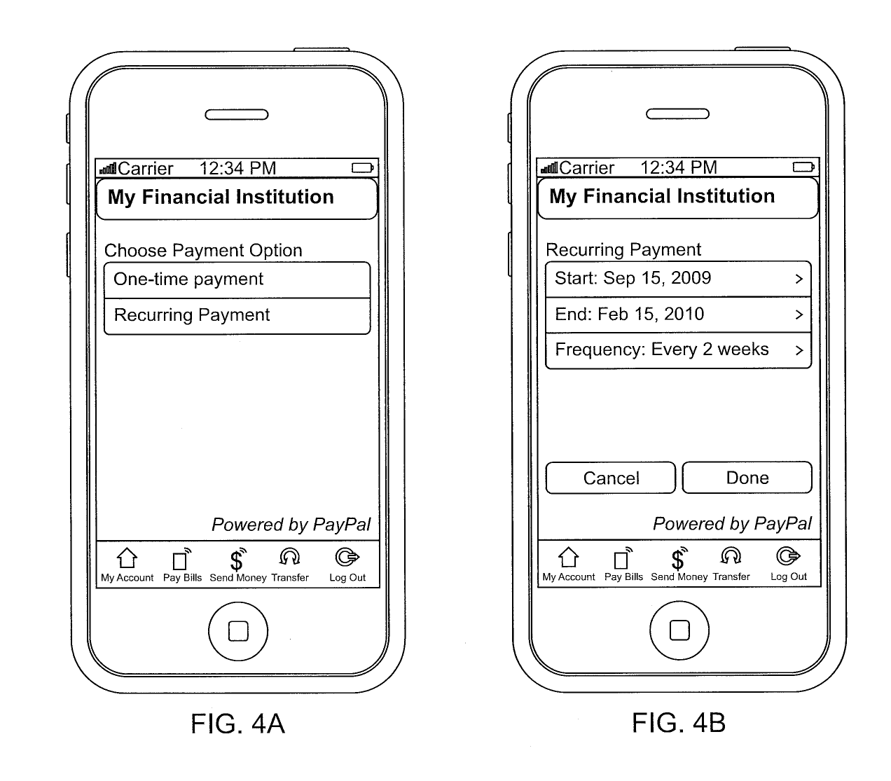

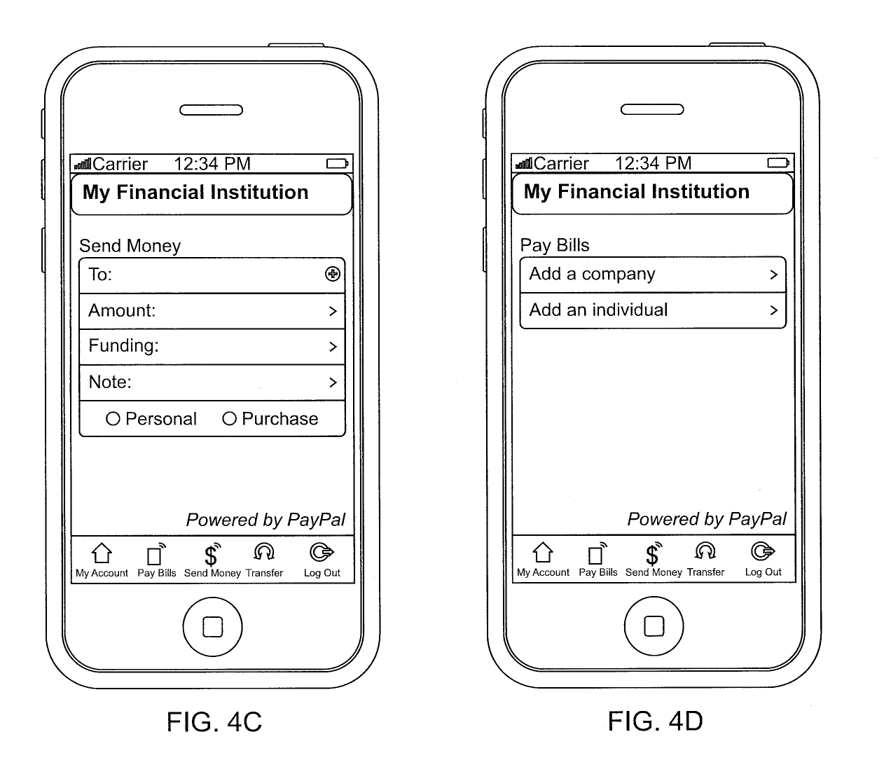

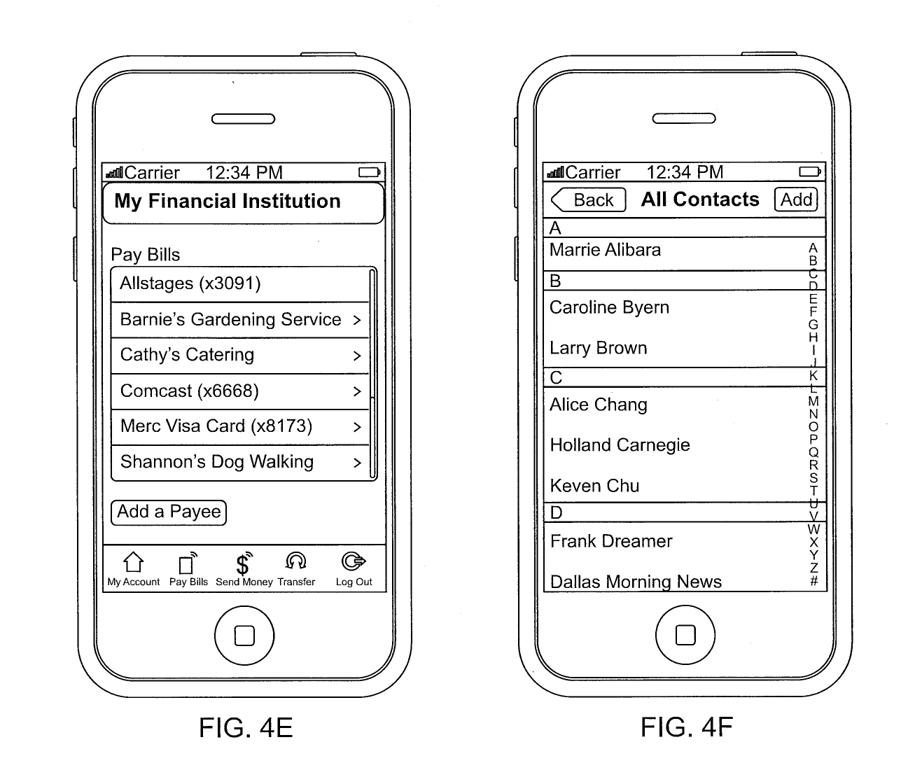

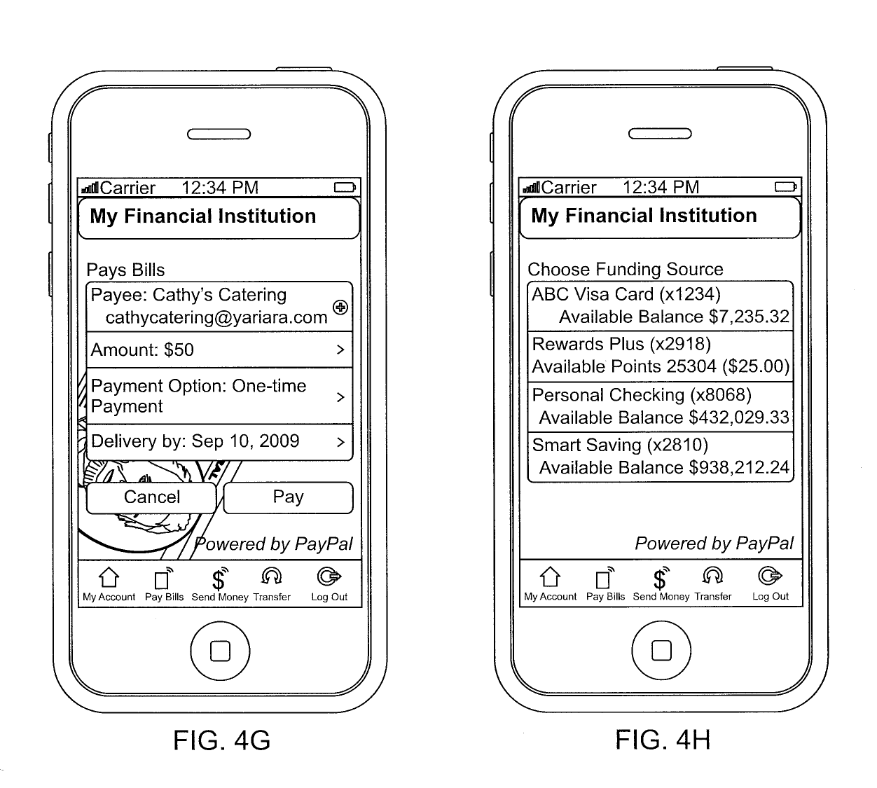

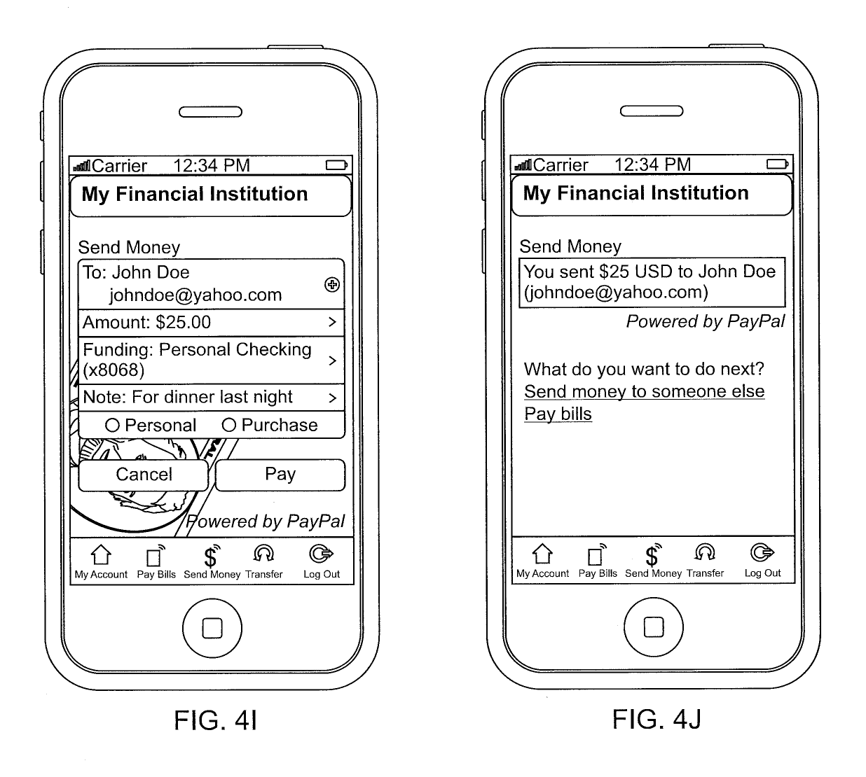

FIGS. 4A-4J are exemplary screen shots of various stages of a payment process described above. In FIG. 4A, a user accesses the user's financial institution (e.g., a bank) through the user's mobile device or smart phone. After logging in and selecting the appropriate payment option or feature, the user may see a screen that allows the user to select whether the payment will be a one-time payment or a recurring payment. By selecting or tapping the appropriate option, the user can be taken to the next step. For a one-time payment, the user may be taken directly to FIG. 4C. If the user selects a recurring payment, the user may be shown the display of FIG. 4B. In FIG. 4B, the user may select a start date for the payment, an end date for the payment, and a recurrence frequency for the payment.

FIG. 4C shows a screen having fields to enable to user to specify the payee, the amount to be sent, the funding source, a note or message, and an indication of whether the payment is for a purchase or personal. By tapping or selecting the payee field, the user may be shown a screen, in FIG. 4D, that allows the user to select the payee as a company or an individual.

If the payee is going to be a company, the user may be shown a list of previously entered or selected companies, such as in FIG. 4E. The user can then easily select one of the listed companies as the payee, where each company has an identifier, such as an email address and/or a phone number. If the user selects an individual as the payee, the user may see a contact list of everyone in the user's contact list, such as shown in FIG. 4F, or other contact list. The user can then select the desired payee from the contact list. Note that the user may also manually enter a payee identifier, and not use the lists shown in the previous figures.

FIG. 4G shows a display where the user is ready to make a payment. As shown, a payee is identified (as a business selected from FIG. 4E and automatically populated with the business email address), an amount is shown, a payment option of a one-time payment is shown, and a delivery date is shown. The delivery date can be selected by the user, such as from a calendar. If everything is correct, the user can select the “Pay” button to process the payment request. If anything needs to be revised, the user can select the appropriate field to correct the information. In this example, no funding source was selected. The reason may be that there is only one funding source available or preselected.

However, if the user has multiple funding sources available and wishes to select one, FIG. 4H is a screen that allows the user to select a funding source for the payment. Four funding sources for the bank are shown, along with available balance or value. In FIG. 4H, the user's personal checking account is selected, such as by tapping the Personal Checking bar.

FIG. 4I shows another display where the user is ready to make a payment. The payee is identified with a name and email address, the amount is shown, a funding source is shown, along with a note or message from the user to the payee. The user has also selected the payment as being personal. If everything is acceptable, the user can select the “Send Now” button to initiate the payment request.

If successful, the user may see the notification in FIG. 4J. The display includes the amount sent and the payee's name and email address. Note that the identity of the payment provider is included in displays from the bank site. This allows both the bank and the payment provider to increase branding opportunities to users.

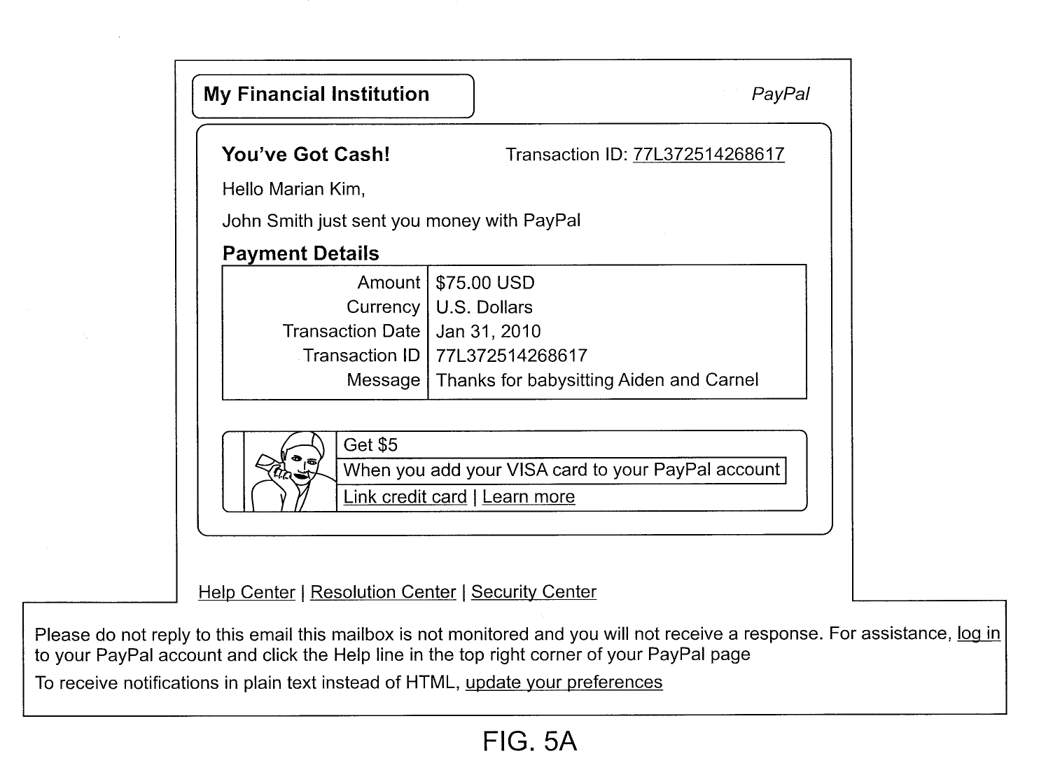

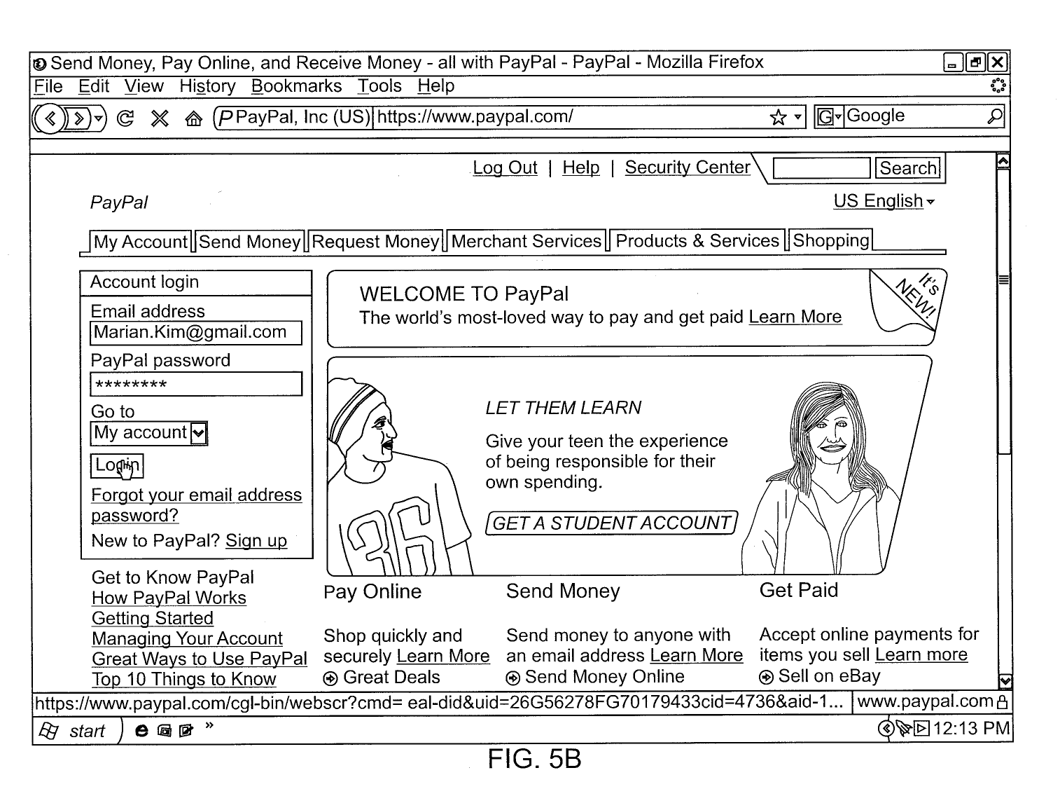

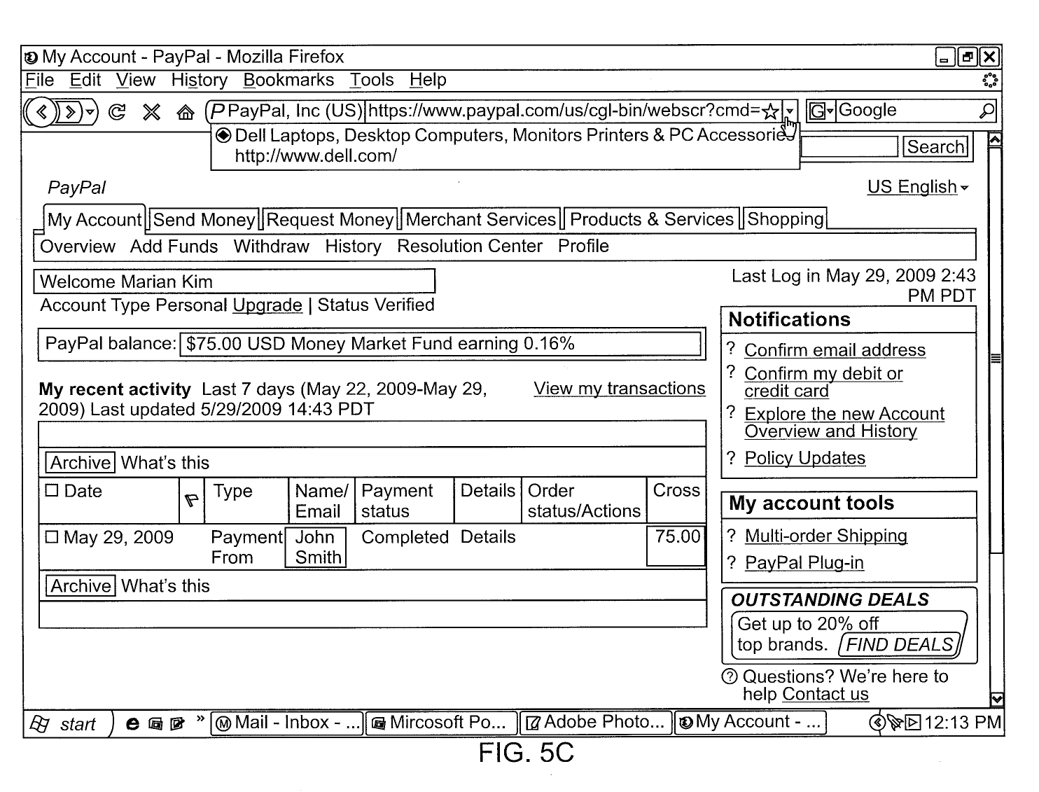

FIGS. 5A-5C are exemplary screen shots a payee sees after a payment is sent from a user's financial institution site or app. FIG. 5A is an email received by the payee, indicating details of the payment. In this example, the user or sender is identified, along with the payment provider. Details of the payment include the amount, currency, date sent, a transaction number, and a message. This email informs the payee that the payee has received a payment. The email can be sent to the payee's PC or mobile device. Thus, the payee can retrieve the funds as desired, such as the payee accessing the payment provider site.

FIG. 5B shows the payee logging into the payment provider site to access the payee's account. This can be through a browser or a mobile App browser. After entering an email address and password, the payee may be displayed the user's account information, as shown in FIG. 5C. The date of payment, the sender, payment status, and amount are shown, so that the payee can see details of a payment as well as manage the account from the payment provider site.

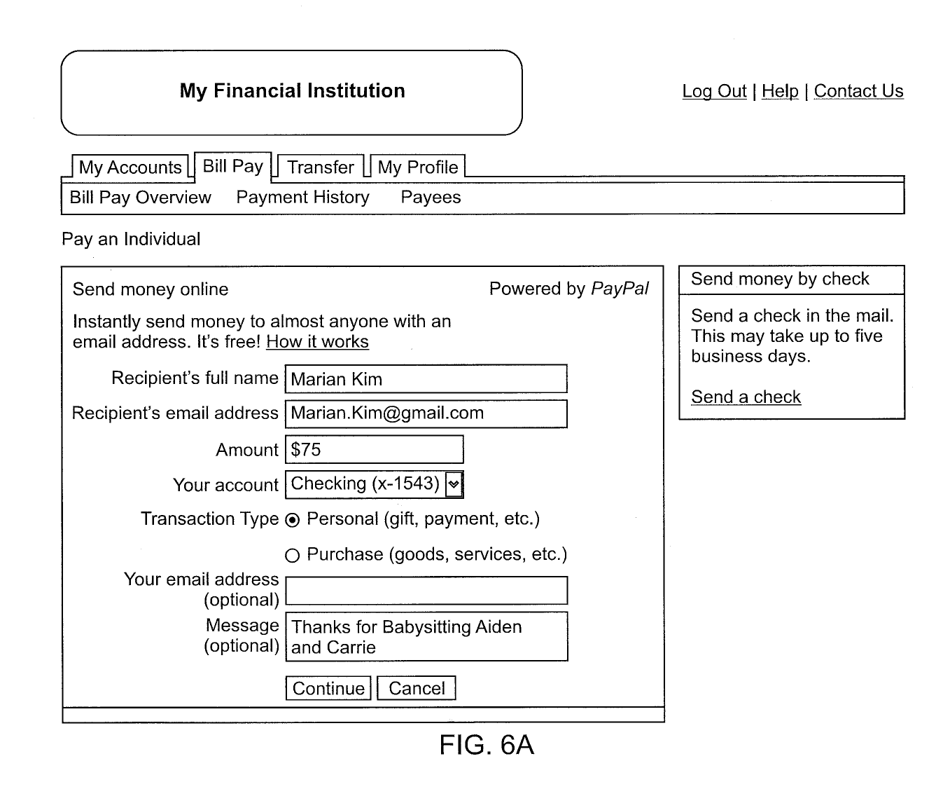

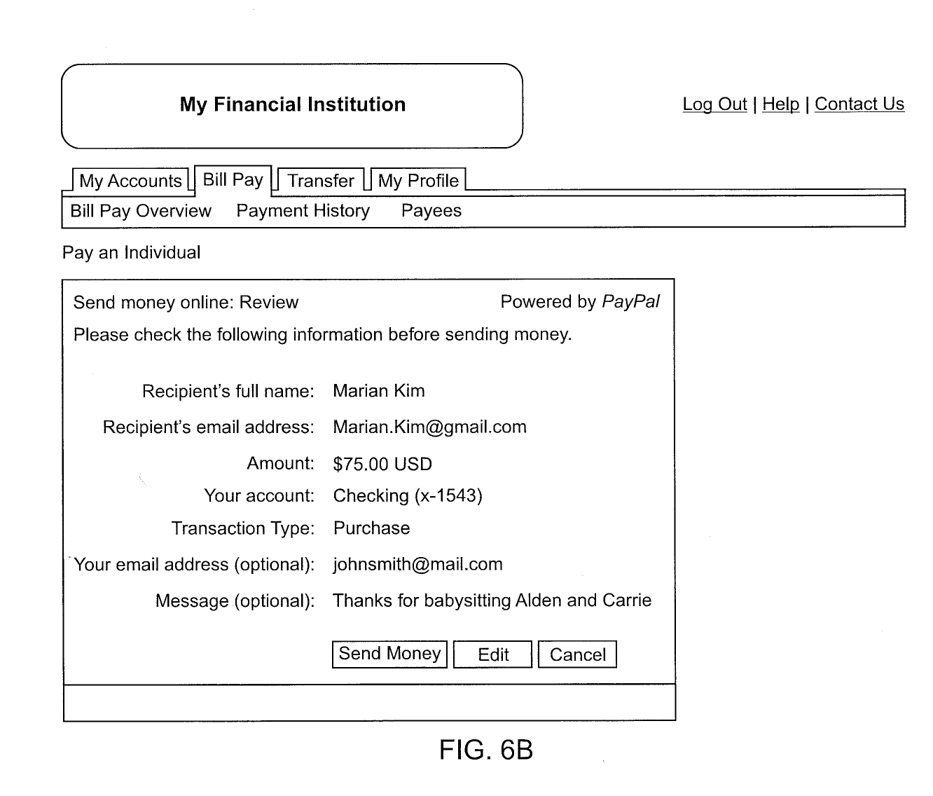

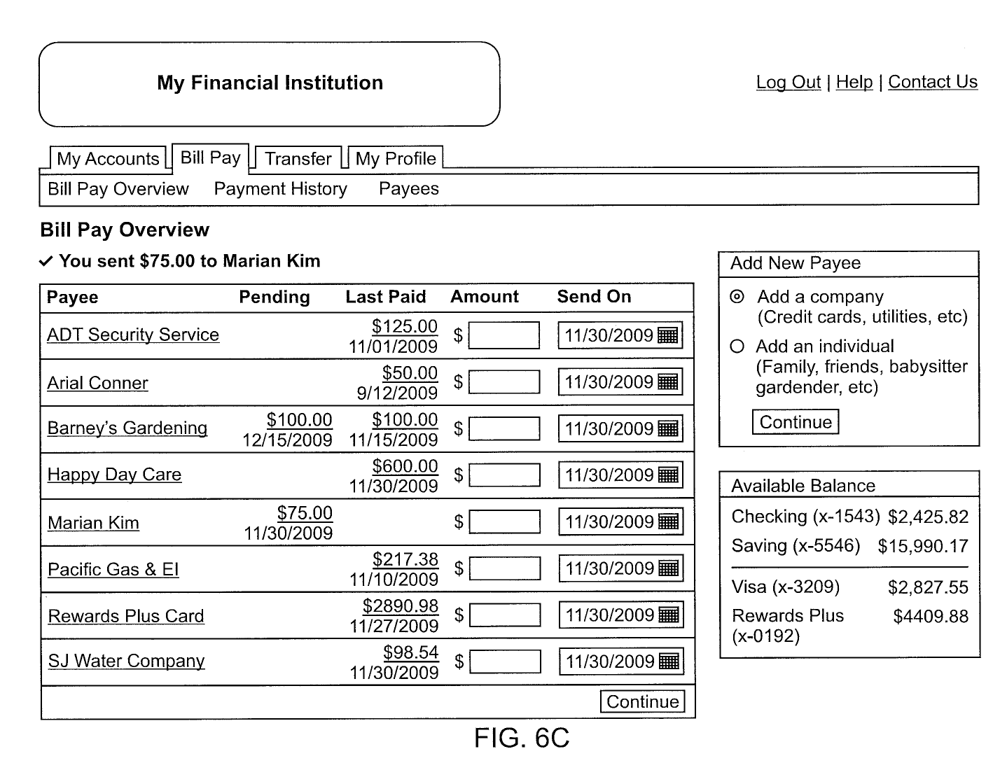

FIGS. 6A-6C are exemplary screen shots a user or sender sees for making a payment through the user's financial institution. In FIG. 6A, the user has entered all the desired information into the user's bank site after selecting the Bill Pay option. The user has selected an individual as the payee. Details include the payee's name, email address, payment amount, funding source, type of payment, and a message to the payee. Details can be revised before confirming. Once ready to continue, the user may select the “Continue” button.

FIG. 6B shows a payment review page. In comparing the details with FIG. 6A, it is seen that the user has added the user's email to the payment and changed the transaction type from “Personal” to “Purchase”. When the user is ready to make the payment, the user may select the “Send Money” button.

After payment, the user can see a summary of payments, along with other account information, such as shown in FIG. 6C. A confirmation that the payment was sent is visible, along with a list of previous payees, last paid amount, last paid date, and pending payments. The screen also allows the user to quickly and easily make a payment to a previous payee, add a company as a new payee, or add an individual as a new payee. The user is also able to see current balances of various user accounts on the page.

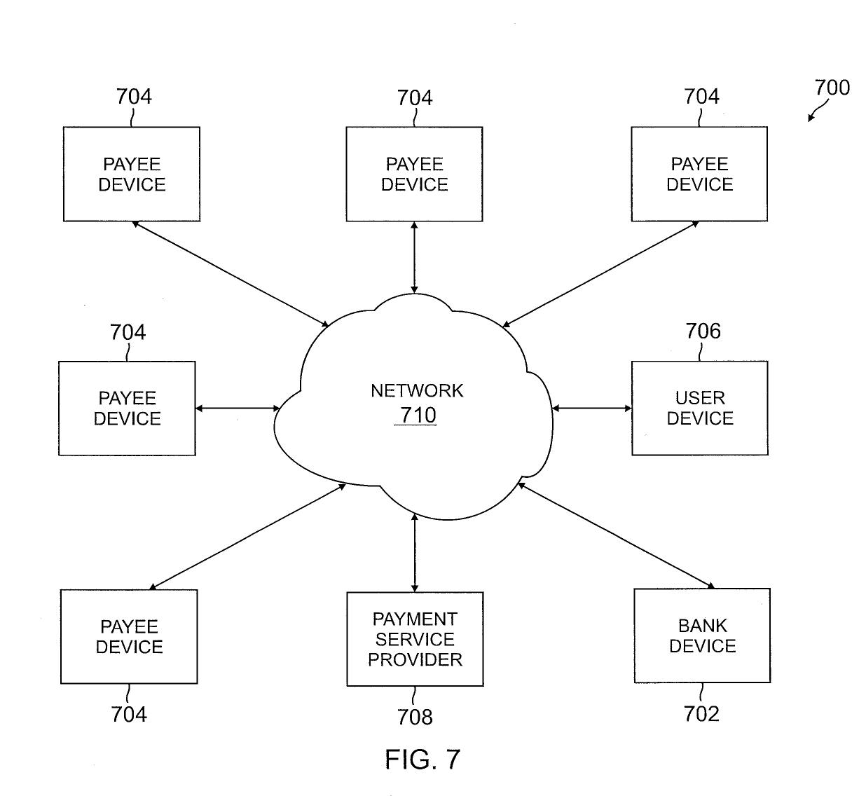

FIG. 7 shows an embodiment of a networked system 700 used in the payment processes described above. Networked system 700 includes a financial institution or bank device 702, a plurality of payee devices 704, a user device 706 (payer), and a payment provider device 708 in communication over a network 710.

Bank device 702, payee devices 704, user device 706, and payment provider device 708 (discussed in further detail below) may each include one or more processors, memories, and other appropriate components for executing instructions such as program code and/or data stored on one or more computer readable mediums to implement the various applications, data, and steps described herein. For example, such instructions may be stored in one or more computer readable mediums such as memories or data storage devices internal and/or external to various components of system 700, and/or accessible over the network 710.

Network 710 may be implemented as a single network or a combination of multiple networks. For example, in various embodiments, network 710 may include the Internet and/or one or more intranets, landline networks, wireless networks, and/or other appropriate types of networks.

Payee devices 704 and user device 706 may be implemented using any appropriate combination of hardware and/or software configured for wired and/or wireless communication over network 710. For example, in one embodiment, payee devices 704 and user device 706 may be implemented as a smart phone of a user in communication with the Internet or mobile carrier network. In other embodiments, payee devices 704 and user device 706 may be a personal computer, personal digital assistant (PDA), laptop computer, tablet, and/or other types of computing devices.

Payee devices 704 and user device 706 may include one or more browser applications which may be used, for example, to provide a convenient interface to permit the user to browse information available over network 710. For example, the browser application may be implemented as a web browser or mobile App configured to view information available over the Internet.

Payee devices 704 and user device 706 may also include one or more toolbar applications or mobile apps which may be used, for example, to provide processing for performing desired tasks in response to operations selected by the user. In one embodiment, the application may display a user interface in connection with the browser application.

Payee devices 704 and user device 706 may further include other applications or mobile apps as may be desired in particular embodiments to provide desired features to payee devices 704 and user device 706. In particular, the other applications or apps may include a payment application/app for payments received or made through the payment provider from a user's banking site. The other applications/apps may also include security applications for implementing user-side security features, programmatic user applications for interfacing with appropriate application programming interfaces (APIs) over network 710 or other types of applications. Email and/or text applications/apps may also be included, which allow the user to send and receive notifications, such as emails and/or text messages, through network 710. Payee devices 704 and user device 706 includes one or more user and/or device identifiers which may be implemented, for example, as operating system registry entries, cookies associated with the browser application, identifiers associated with hardware of payee devices 704 and user device 706, or other appropriate identifiers, such as a phone number. In one embodiment, the user identifier may be used by the payment provider to associate the payer with a particular account maintained by the payment provider.

Payee devices 704, if operated by a merchant as opposed to an individual, may be maintained, for example, by an on-line merchant, digital goods seller, individual seller, restaurant, bar, and/or entity or person offering various products and/or services in exchange for payment to be received over network 710. In this regard, payee devices 704 may include a database identifying available products and/or services (e.g., collectively referred to as items) which may be made available for viewing and purchase by the payer.

Payee devices 704 also includes a checkout application/app which may be configured to facilitate the purchase by the payee of items. The checkout application/app may be configured to accept payment information from the user, and/or from the payment service provider over network 710.

Bank device 702 may be a computing device, such as a server, that includes components and software to allow it to communicate with user device 706, such as to send information to and receive information from user device 706 through a bank site or app, communicate with payee devices 704, such as to send a notification to a payee device for confirmation of a payment, and/or communicate with payment provider device 708, such as sending a payment request, receiving a settlement report, and/or transmitting funds.

Payment provider device 708 may be a computing device, such as a server, that includes components and software to allow it to communicate with user device 706, such as to send a notification to user device 706 to confirm a sent payment, communicate with payee devices 704, such as to send a notification to a payee device for confirmation of a payment and/or to create an account to retrieve funds, and/or communicate with bank device 702, such as receiving a payment request from the bank device, sending a settlement report, and/or processing payment requests including transfer and withdrawal of funds. Payment provider device 708 may also include databases that store information about user accounts, such as identifiers, account numbers, balances, funding sources, passwords, etc.

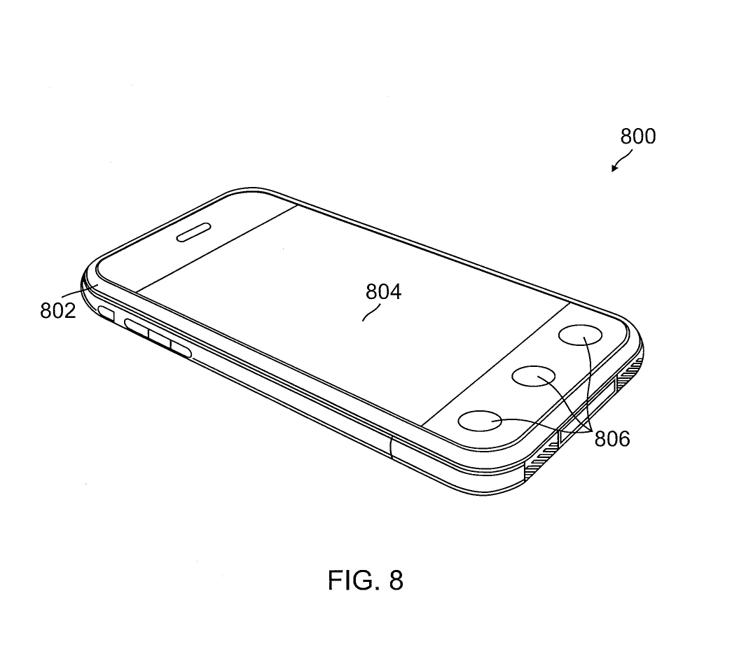

FIG. 8 shows an embodiment of a user device 800. User device 800 may be any or all of the payee devices and/or user devices described herein. User device 800 includes a chassis 802 having a display 804 and an input device including display 804 and a plurality of input buttons 806. One of skill in the art will recognize that user device 800 is a portable or mobile phone including a touch screen input device and a plurality of input buttons that allow the functionality discussed above with reference to the methods discussed herein. However, a variety of other portable or mobile payer devices or computing devices may be used in the methods described without departing from the scope of the present disclosure.

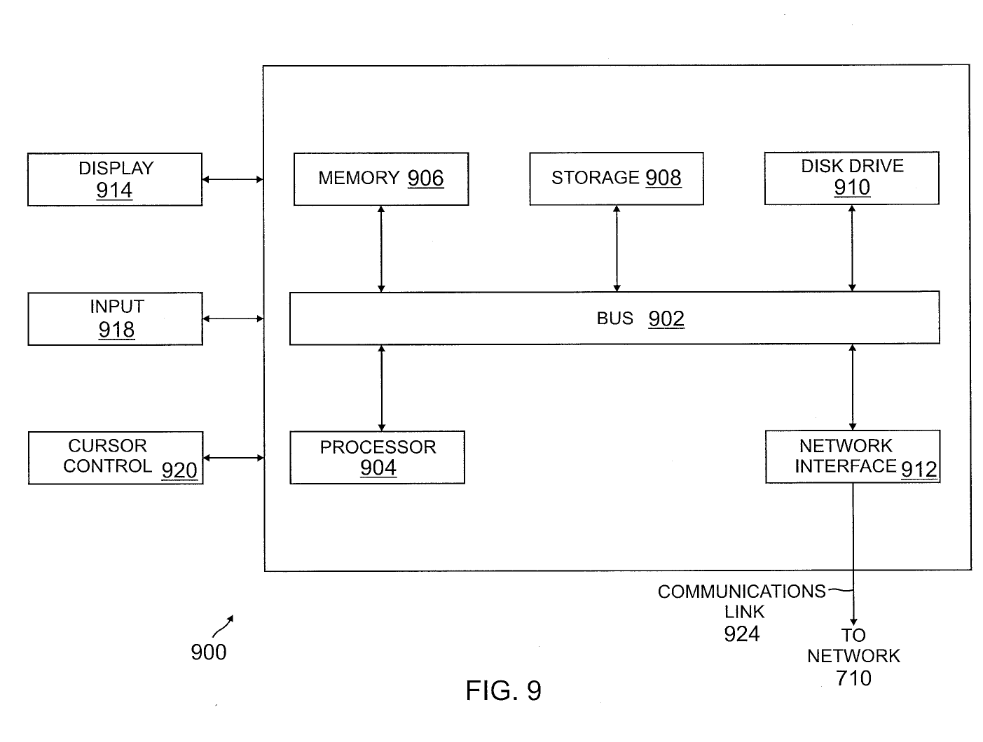

FIG. 9 shows an embodiment of a computer system 900 suitable for implementing, for example, various payer, user, payee, bank, and payment provider devices described herein. In various implementations, the device(s) may comprise a computing device (e.g., a computer, laptop, smart phone, PDA, tablet, etc.) capable of communicating with network 710.

In accordance with various embodiments of the present disclosure, computer system 900, such as a computer, smart phone, tablet, and/or a network server, includes a bus 902 or other communication mechanism for communicating information, which interconnects subsystems and components, such as a processing component 904 (e.g., processor, micro-controller, digital signal processor (DSP), etc.), a system memory component 906 (e.g., RAM), a static storage component 908 (e.g., ROM), a disk drive component 910 (e.g., magnetic or optical), a network interface component 912 (e.g., modem or Ethernet card), a display component 914 (e.g., CRT, touch screen, or LCD), an input component 918 (e.g., keyboard, keypad, touch screen, or virtual keyboard), and/or a cursor control component 920 (e.g., mouse, pointer, control for inputting to a touch screen, or trackball). In one implementation, disk drive component 910 may comprise a database having one or more disk drive components.

In accordance with embodiments of the present disclosure, computer system 900 performs specific operations by processor 904 executing one or more sequences of instructions contained in system memory component 906, such as described herein with respect to the payer device, the payee device, the user device, bank device, and/or the payment provider device. Such instructions may be read into system memory component 906 from another computer readable medium, such as static storage component 908 or disk drive component 910. In other embodiments, hard-wired circuitry may be used in place of or in combination with software instructions to implement the present disclosure.

Logic may be encoded in a computer readable medium, which may refer to any medium that participates in providing instructions to processor 904 for execution. Such a medium may take many forms, including but not limited to, non-volatile media, volatile media, and transmission media. In various implementations, non-volatile media includes optical or magnetic disks, such as disk drive component 910, volatile media includes dynamic memory, such as system memory component 906, and transmission media includes coaxial cables, copper wire, and fiber optics, including wires that comprise bus 902. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 900. In various other embodiments of the present disclosure, a plurality of computer systems 900 coupled by a communication link 924 to network 710 (e.g., such as a LAN, WLAN, PTSN, and/or various other wired or wireless networks, including telecommunications, mobile, and cellular phone networks) may perform instruction sequences to practice the present disclosure in coordination with one another.

Computer system 900 may transmit and receive messages, data, information and instructions, including one or more programs (i.e., application code) through communication link 924 and network interface component 912. Network interface component 912 may include an antenna, either separate or integrated, to enable transmission and reception via communication link 924. Received program code may be executed by processor 804 as received and/or stored in disk drive component 910 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the scope of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure. Having thus described embodiments of the present disclosure, persons of ordinary skill in the art will recognize that changes may be made in form and detail without departing from the scope of the present disclosure. Thus, the present disclosure is limited only by the claims.

What is claimed is:

1. A method, comprising:
receiving, by a processor of a payment provider server, a payment request transmitted from a financial institution server, wherein the payment request is generated from a webpage maintained by the financial institution server, wherein the payment request is initiated by a user of the webpage, and wherein the user has an institution account maintained by the financial institution server and a payment account maintained by the payment provider server;
determining, by the processor, a payee from a payee identifier contained in the payment request, wherein the payee identifier is an email address or a phone number, and wherein the payee does not have an account with the financial institution; and
processing the payment request by performing the following:
debiting the payment account by a first amount, wherein the first amount is insufficient to satisfy the payment request;
debiting an account of the financial institution maintained by the payment provider server by a second amount; and
crediting an account of the payee maintained by the payment provider server by the first amount debited and the second amount debited to satisfy the payment request.

2. The method of claim 1, wherein the processing comprises debiting a third account of a third party with the payment provider by a third amount, wherein the third party receives payment for the third amount from the financial institution.

3. The method of claim 1, wherein the payment request further comprises an indication of a payment amount and a funding source associated with the institution account.

4. The method of claim 3, wherein the payment request further comprises an indication of a payment recurrence of multiple payments.

5. The method of claim 1, wherein the payee identifier is selected from a list accessible to the user through the webpage of the financial institution.

6. A system, comprising:
a computer storage storing account information for a plurality of users having an account with a payment provider, wherein the account information comprises a payee identifier consisting of an email address and/or a phone number; and
a processor operable to:
receive a payment request transmitted from a financial institution server, wherein the payment request is generated from a webpage maintained by the financial institution server, wherein the payment request is initiated by a user of the webpage, and wherein the user has an institution account maintained by the financial institution server and a payment account maintained by the payment provider server;
determine a payee from a payee identifier contained in the payment request, wherein the payee identifier is an email address or a phone number, and wherein the payee does not have an account with the financial institution; and
process the payment request by performing the following:
debit the payment account by a first amount, wherein the first amount is insufficient to satisfy the payment request;
debit an account of the financial institution maintained by the payment provider server by a second amount; and
credit an account of the payee maintained by the payment provider server by the first amount debited and the second amount debited to satisfy the payment request.

7. The system of claim 7, wherein the processor is further operable to debit a third account of a third party with the payment provider by a third amount, wherein the third party receives payment for the third amount from the financial institution.

8. The system of claim 7, wherein the payment request further comprises an indication of a payment amount and a funding source associated with the institution account.

9. A method, comprising:
receiving, by a processor of a financial institution server, a payment request initiated by a user, wherein the payment request is generated from a webpage maintained by the financial institution server, and wherein the user has an institution account maintained by the financial institution server;
transmitting, by the processor, the payment request to a payment provider server, wherein the payment request includes a payee identifier consisting of an email address and/or a phone number, wherein the user has a payment account maintained by the payment provider server;
debiting the payment account by a first amount, wherein the first amount is insufficient to satisfy the payment request;
debiting the institution account by a second amount; and
crediting an account of the payee maintained by the payment provider server by the first amount debited and the second amount debited to satisfy the payment request.

10. The method of claim 11, further comprising transmitting funds to the payment provider server from an account of the financial institution maintained by the payment provider server.

11. The method of claim 11, further comprising transmitting funds to a third party, wherein the third party has an account maintained by the payment provider server.

12. The method of claim 11, wherein the payment request further comprises an indication of a payment amount and a funding source associated with the institution account.
